(19) United States
(12) Patent Application Publication
(10) Pub. No.: US 2026/0143264 A1
(43) Pub. Date: May 21, 2026

(54) METHOD FOR READING A PIXEL WITH CHARGE/VOLTAGE DUAL CONVERSION GAIN AND CORRESPONDING SYSTEM

(71) Applicant: STMicroelectronics International N.V., Geneva (CH)

(72) Inventor: Cedric TUBERT, SAINT-EGREVE (FR)

(73) Assignee: STMicroelectronics International N.V., Geneva (CH)

(21) Appl. No.: 19/388,131

(22) Filed: Nov. 13, 2025

(30) Foreign Application Priority Data
Nov. 15, 2024 (FR) FR2412482

(51) Int. Cl. H04N 25/78; H04N 25/76; H04N 25/771

(52) U.S. Cl. CPC H04N 25/78; H04N 25/771; H04N 25/7795

(57) ABSTRACT

A mode control signal places a pixel into either a high conversion gain (HCG) mode or a low conversion gain (LCG) mode. A conversion operation for the pixel includes: resetting a reading node of the pixel placed in the LCG mode; followed first transitioning the mode control signal to place the pixel in the HCG mode; then first charge transferring from the photodiode to the reading node with HCG; then second transitioning the mode control signal to place the pixel in the LCG mode; followed by second charge transferring from the photodiode to the reading node with LCG; followed by third transitioning the mode control signal to place the pixel back in the HCG mode. During low-gain conversion, a pulse of the mode control signal is generated which frames the pulse triggering charge transfer. This enables only three ramps to be used.

### PRIORITY CLAIM

This application claims the priority benefit of French Application for Patent No. FR2412482, filed on Nov. 15, 2024, the content of which is hereby incorporated by reference in its entirety to the maximum extent allowable by law.

### TECHNICAL FIELD

Embodiments and implementations relate to the processing of analog signals, especially processing of analog signals delivered by pixels using a method known to the person skilled in the art as a charge/voltage Dual Conversion Gain (DCG) reading.

### BACKGROUND

Dual Conversion Gain (DCG) reading includes so-called High Conversion Gain (HCG) reading and so-called Low Conversion Gain (LCG) reading.

HCG reading provides low reading noise at the expense of the maximum signal converted.

LCG reading has a higher noise floor with the advantage of converting a larger maximum useful signal.

This DCG reading is the basis of the so-called dynamic extension conversion techniques: Dynamic level-down extension by minimizing noise (HCG reading); and Dynamic level-up extension by virtue of lower-gain reading (LCG reading).

The pixel size in image sensors using CMOS technology tends to get smaller and smaller, leading to a reduction in the Full Well Capacity (FWC) of each pixel, which is directly related to the intrinsic Dynamic Range (DR) of the sensor.

The current image sensor market requires sensors whose pixels and corresponding reading schemes are compatible with dual conversion gain (DCG) reading.

However, this implies long reading (conversion) times with a reduced image rate.

This is the case in the DCG-type reading methods described in U.S. Pat. Nos. 10,431,608 B2 and 10,356,351 B1 (incorporated herein by reference) in which reading times with dual conversion gain are in the order of 12 microseconds.

There is therefore a need for a DCG-type reading method with a reduced reading time for each pixel.

### SUMMARY

One aspect provides a method for reading a pixel with charge/voltage Dual Conversion Gain (DCG). The pixel has a photodiode capable of storing charges and a reading node. The pixel can be placed in response to a so-called mode control signal, either in a high conversion gain (HCG) mode or in a low conversion gain (LCG) mode.

The method comprises a reading operation successively comprising: a) a reset of the reading node of the pixel placed in its low conversion gain mode, followed by a first transition of the mode control signal to place the pixel in its high conversion gain (HCG) mode; b) with the pixel in high conversion gain mode, a first charge transfer from the photodiode to the reading node with a high conversion gain; and c) a second transition of the control signal to place the pixel in its low conversion gain mode, followed by a second charge transfer from the photodiode to the reading node with a low conversion gain, followed by a third transition of the control signal, opposite to the second transition, to place the pixel back in its high conversion gain mode.

Charge transfer is achieved by turning on, with a transfer pulse, a transfer transistor connected between the pixel photodiode and the reading node.

In addition, the pixel generally includes a first capacitor having a first terminal connected to the reading node and to the photodiode via the transfer transistor and a second terminal connected to the ground, and a second capacitor having a first terminal and a second terminal connected to the ground.

The first terminals of the first and second capacitors are connected together via another transistor, referred to as a mode transistor, controlled by the control signal.

This mode transistor makes it possible to define the conversion mode (high gain or low gain) of the pixel and is also connected to the transfer transistor.

The second capacitor makes it possible to store charges that would eventually have “overflowed” the mode transistor during a charge transfer.

During the first transition or the third transition (falling edges, for example) of the mode control signal, the mode transistor is off and only the first capacitor is connected to the photodiode of the pixel via the transfer transistor. The pixel is then in its high conversion gain mode.

During the second transition (rising edge, for example) of the mode control signal, the mode transistor is on, thereby connecting the first two terminals of the two capacitors together and to the photodiode of the pixel via the transfer transistor. The pixel is then in its low conversion gain mode.

The second transition (rising edge) of the control signal (prior to the transfer pulse) followed by the third transition (falling edge) of the control signal (subsequent to the transfer pulse) define a control pulse (“return trip”) of the mode control signal framing the transfer pulse.

During the second transition (rising edge) of the mode control signal, there is a positive injection of charge from the first capacitor (connected to the reading node) to the second capacitor.

And this positive injection of charge is compensated for by a negative injection of charge from the second capacitor to the first capacitor during the third transition (falling front) of the mode control signal.

In other words, the full pulse of the mode control signal enables this positive injection of charges to be compensated for by virtue of said “return trip”’.

This enables the conversion implemented in step c) to operate under the same conditions as the conversions implemented in steps a) and b).

The implementation of a fourth conversion, which is necessary and described in the prior art hereinbefore, is thus avoided, thereby reducing the conversion time.

The pixel includes an output node connected to the reading node.

According to one implementation mode: step a) also includes, subsequent to the first transition of the mode control signal, a comparison of a first output voltage delivered to the output node with a first ramp signal and a determination of a first digital counting value representative of a first duration between the start of the first ramp signal and a first instant when said first output voltage intersects the first ramp signal; step b) also includes, subsequent to the first charge transfer, a comparison of a second output voltage delivered to the output node with a second ramp signal and a determination of a second digital counting value representative of a second duration between the start of the second ramp signal and a second instant when said second output voltage intersects the second ramp signal; and step c) also includes, subsequent to the third transition of the mode control signal, a comparison of a third output voltage delivered to the output node with a third ramp signal and a determination of a third digital counting value representative of a third duration between the start of the third ramp signal and a third instant when said third output voltage intersects the third ramp signal.

Since, as mentioned hereinbefore, there is no need for a fourth conversion, there is no need herein to use a fourth ramp signal.

According to one advantageous mode of implementation, the third ramp signal starts at a level lower than the level of the start of the second ramp signal.

Indeed, some of the charges have already been converted during the HCG conversion, so it is unnecessary to convert them a second time during the LCG conversion.

According to another aspect, a system comprises: a pixel having a photodiode configured to store charges; a reading node; wherein the pixel is placeable in response to a mode control signal in either a high conversion gain mode or a low conversion gain mode; and a device configured to read the charge/voltage conversion dual conversion gain pixel, including a processing circuit configured to deliver said mode control signal and to implement a reading operation successively including: a) a reset of the reading node of the pixel placed in its low conversion gain mode, followed by a first transition of the mode control signal so as to place the pixel in its high conversion gain (HCG) mode; b) with the pixel in the high conversion gain mode, a first charge transfer from the photodiode to the reading node with a high conversion gain; and c) a second transition of the mode control signal, to place the pixel in its low conversion gain mode, followed by a second charge transfer from the photodiode to the reading node with a low conversion gain, followed by a third transition of the control signal, opposite to the second transition to place the pixel back in its high conversion gain mode.

According to one embodiment, the pixel includes an output node connected to the reading node, and the processing circuit includes a ramp generator configured to deliver ramp signals, a comparison circuit, a development circuit and a control circuit.

According to this embodiment, for the implementation of step a), the control circuit is configured to have a first ramp signal delivered by the ramp generator after the first transition of the mode control signal, the comparison circuit is configured to carry out a comparison of a first output voltage delivered to the output node with the first ramp signal, and the development circuit is configured to determine a first digital counting value representative of a first duration between the start of the first ramp signal and a first instant when said first output voltage intersects the first ramp signal; for the implementation of step b), the control circuit is configured to have a second ramp signal delivered by the ramp generator subsequent to the first charge transfer, the comparison circuit is configured to carry out a comparison of a second output voltage delivered to the output node with the second ramp signal, and the development circuit is configured to determine a second digital counting value representative of a second duration between the start of the second ramp signal and a second instant when said second output voltage intersects the second ramp signal; and for the implementation of step c), the control circuit is configured to have a third ramp signal delivered by the ramp generator subsequent to the third transition of the mode control signal, the comparison circuit is configured to carry out a comparison of a third output voltage delivered to the output node with the third ramp signal, and the development circuit is configured to determine a third digital counting value representative of a third duration between the start of the third ramp signal and a third instant when said third output voltage intersects the third ramp signal.

According to one embodiment, the ramp generator is configured to deliver the third ramp signal starting at a level lower than the level of the start of the second ramp signal.

According to another aspect, there is provided a sensor, including a pixel matrix organized in rows and columns, and including respectively at the foot of each column, a reading device as defined hereinbefore.

### BRIEF DESCRIPTION OF THE DRAWINGS

Further advantages and characteristics of the invention will appear upon examining the detailed description of non-limiting modes of implementation and embodiments, and from the appended drawings, wherein:

FIG. 1 is a circuit diagram for a single pixel circuit;

FIG. 2 is a circuit diagram for a two pixel circuit;

FIG. 3 is a block diagram of a system including a pixel circuit;

FIG. 4 is a timing diagram for a method of reading the pixel;

FIG. 5 illustrates voltage/load curves for conversions;

FIG. 6 is a timing diagram for a method of reading the pixel; and

FIG. 7 schematically illustrates a sensor including a matrix of pixels.

### DETAILED DESCRIPTION

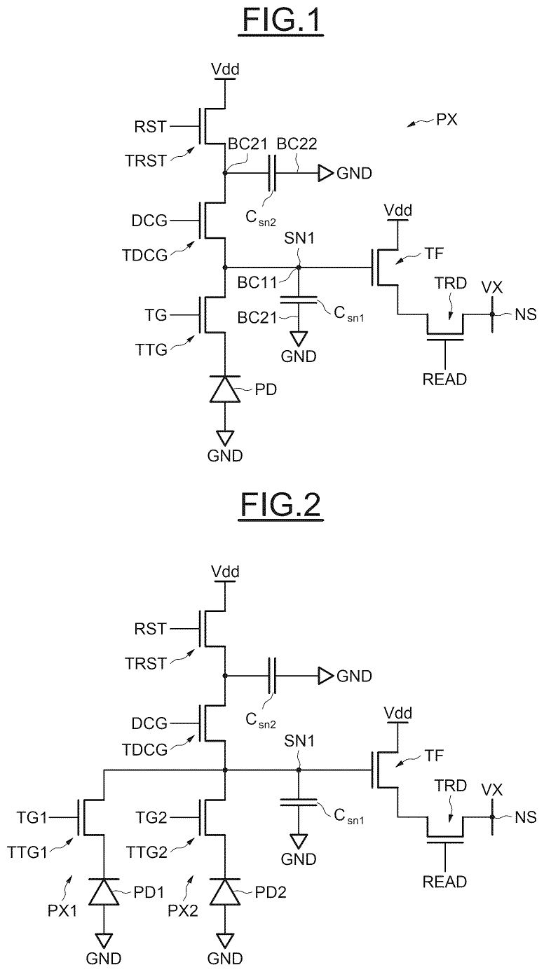

In FIG. 1, the reference PX designates a pixel.

This pixel conventionally includes a PD photodiode integrated into a silicon substrate and associated with a transfer transistor TTG, controlled by a transfer signal TG.

As is well known to those skilled in the art, when a transfer pulse TG is applied to the gate of the transfer transistor TTG, the transistor TTG is turned on, enabling the charges accumulated in the photodiode to be transferred to the reading node SN1 of the pixel.

This reading node SN1 is connected to an output node NS of the pixel via a follower transistor TF and a reading transistor TRD controlled at its gate by a reading control signal READ.

During the reading operation, the reading control signal READ is in the high state, and the output node delivers the output voltage VX.

The pixel PX also includes a first capacitor Cₛₙ₁ having a first terminal BC11 (corresponding to the reading node SN1), connected to the transfer transistor TG, and a second terminal BC12 connected to ground GND.

This first capacitor is formed by stray capacitances and metallization of the integrated circuit.

The pixel PX also includes a second capacitor Cₛₙ₂ having a first terminal BC21 and a second terminal BC22 connected to the ground GND.

This second capacitor Cₛₙ₂ is also formed by stray capacitances and metallizations of the integrated circuit.

The first two terminals BC11 and BC21 of these two capacitors are connected to each other via a so-called mode transistor TDCG, controlled by a mode control signal DCG.

When the transistor TDCG is turned off (signal TDCG in the low state), only the first capacitor is connected to the transfer transistor TTG and the pixel is in a high conversion gain (HCG) mode.

Reading the pixel is therefore performed with a charge/voltage high conversion gain in the presence of a transfer pulse on the signal TG.

When the TDCG transistor is on (signal TDCG in the high state), the two capacitors are connected to the transfer transistor TG and the reading node SN1, and the pixel is in a low conversion gain (LCG) mode.

Reading the pixel is therefore performed with a charge/voltage low conversion gain in the presence of a transfer pulse on the signal TG.

The pixel PX also includes a reset transistor TRST, connected between the supply voltage Vdd and the mode transistor TDCG (and therefore the first terminal BC21 of the second capacitor Cₛₙ₂) and controlled by a reset signal RST.

FIG. 2 illustrates two pixels PX1 and PX2.

The pixel PX1 has its photodiode PD1 associated with the transfer transistor TTG1 controlled by the transfer signal TG1, and the pixel PX2 has its photodiode PD2 associated with the transfer transistor TTG2 controlled by the transfer signal TG2.

As illustrated in this FIG. 2, the two pixels PX1 and PX2 share in common the output node NS, the reading node SN1 and the elements TDCG, TRST, Csn1, Csn2, TF and TRD described with reference to FIG. 1.

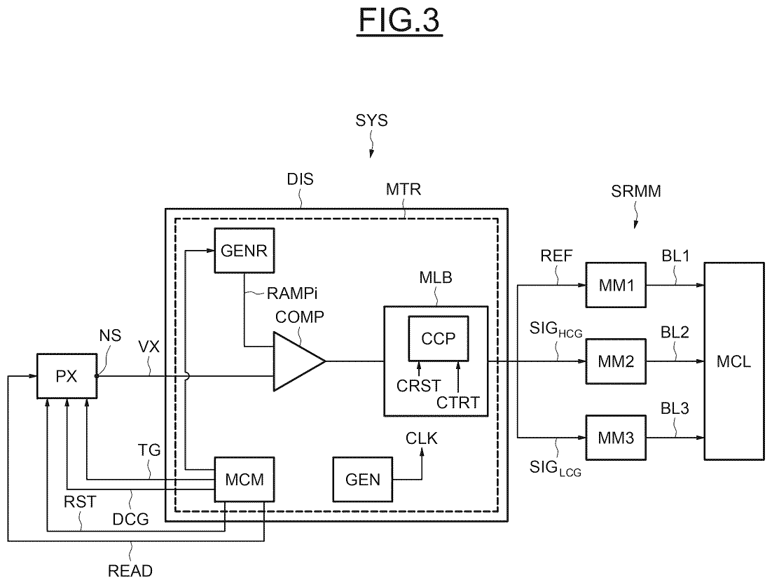

FIG. 3 schematically illustrates a system SYS according to one embodiment.

This system SYS includes a pixel PX, for example of the type illustrated in FIG. 1.

Of course, this pixel could also be one of the pixels PX1, PX2 illustrated in FIG. 2.

The system SYS also includes a device DIS for reading the pixel with charge/voltage dual conversion gain.

This reading device includes a processing circuit MTR configured to deliver said mode control signal DCG and, as will be seen in greater detail hereinafter, to implement a reading operation successively comprising: a) a reset of the reading node SN1 of the pixel PX placed in its low conversion gain (LCG) mode, followed by a first transition of the mode control signal DCG so as to place the pixel in its high conversion gain HCG mode; b) with the pixel in the high conversion gain HCG mode, a first charge transfer from the photodiode to the reading node with a high conversion gain HCG; and c) a second transition of the mode control signal DCG so as to place the pixel in its low conversion gain LCG mode, followed by a second charge transfer from the photodiode to the reading node with low conversion gain LCG, followed by a third transition of the mode control signal DCG, opposite to the second transition so as to place the pixel back in its high conversion gain HCG mode.

It is in step c) that the mode control signal DCG undergoes a “return trip”.

For the implementation of the reading operation, the processing circuit MTR includes: a ramp generator GENR configured to deliver ramp signals RAMPi; a comparator COMP configured to compare the pixel output voltage VX with the ramp signal RAMPi; a generator GEN configured to generate a clock signal CLK; a control circuit MCM configured to control the ramp generator and to deliver the different control signals TG, DCG, RST, READ; a generation circuit MLB configured to generate digital words REF, SIG_{HCG}, SIG_{LCG} (the meaning of which will be explained in greater detail hereinafter) resulting from the pixel reading operation, and especially including a counting circuit CCP clocked from the clock signal CLK and controlled by a counter reset signal CRST and a counter transfer signal CTRT.

A memory is also provided, for example an SRAM memory, referenced SRMM, including memory locations MM1, MM2, MM3 for storing digital words prior to their transfer to calculation circuit MCL (for example incorporated within a microprocessor) via bit lines BL1, BL2, BL3 for calculating other digital values which will be explained hereinbefore.

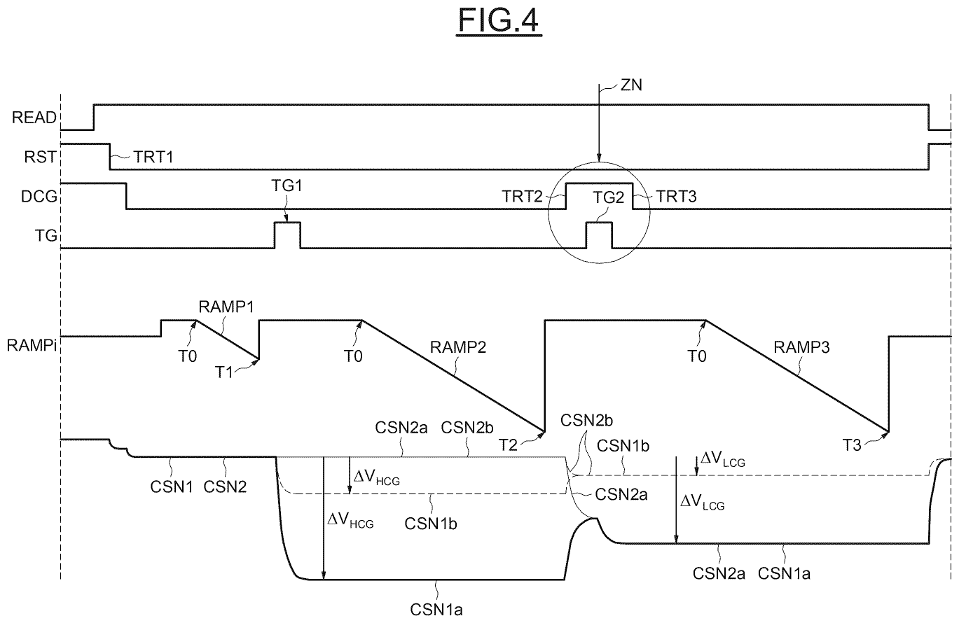

FIG. 4 is now more particularly referred to in order to describe a current reading operation of the method for reading the pixel PX.

The reading operation includes a reset of the counting circuit CCP using the counter reset signal CRST.

The reading operation also includes a rise to the high state of the reading control signal READ and starts with the above-mentioned step a).

In this step a), the pixel reset signal RST and the mode control signal DCG are in the high state, which initializes the reading node SN1 and the first terminal BC21 of the second capacitor Cₛₙ₂ to the supply voltage Vdd.

Then the signal RST drops back to the low state, which leads to negative charges being injected into the first and second capacitors.

A first transition TRT1 is applied to the DCG signal by the control circuit MCM to place the pixel in its high conversion gain HCG mode.

The control circuit MCM activates the ramp generator GENR to have a first ramp signal RAMP1 delivered by the ramp generator.

The comparison circuit CMP carries out a comparison of a first output voltage VX delivered to the output node NS with the first ramp signal RAMP1.

The generation circuit MLB determines a first digital counting value REF representative of a first duration between the start T0 of the first ramp signal RAMP1 and a first instant T1 (schematically represented in FIG. 4) when said first output voltage intersects the first ramp signal RAMP1.

This is conventional and well known to those skilled in the art.

And then the REF value is transmitted to memory location MM1 using the counter transfer signal CTRT.

The first conversion is now complete, and the value REF is a reference value which will be taken into account for the following HCG and LCG conversions, as will be seen hereinafter.

A new reset of the counting circuit CCP is carried out using the counter reset signal CRST.

With the pixel placed in its high conversion gain mode, a first charge transfer from the photodiode of the pixel to the reading node with a high conversion gain HCG is carried out in step b) by use of a pulse TG1 of the transfer signal TG.

The control circuit MCM activates the ramp generator GENR to have a second ramp signal RAMP2 delivered by the ramp generator.

The comparison circuit CMP carries out a comparison of a second output voltage VX delivered to the output node NS with the second ramp signal RAMP2.

The generation circuit MLB determines a second digital counting value SIG_{HCG} representative of a second duration between the start T0 of the second ramp signal RAMP2 and a second instant T2 (schematically represented in FIG. 4) when said second output voltage intersects the second ramp signal RAMP2.

And then the value SIG_{HCG} is transmitted to the memory location MM2 using the counter transfer signal CTRT.

The second conversion (HCG conversion) is complete.

A new reset of the counting circuit CCP is carried out using the counter reset signal CRST.

In step c), a second transition TRT2 is applied to the DCG mode control signal so as to place the pixel in its low conversion gain LCG mode.

This results in a balance of charges between the two capacitors and an injection of charges from the first capacitor Cₛₙ₁ to the second capacitor Cₛₙ₂.

And then, using a pulse TG2 of the transfer signal TG, a second charge transfer is carried out from the photodiode to the reading node SN1 of the pixel with a low conversion gain LCG.

This allows the possible charges still present in the photodiode to be transferred after HCG conversion.

After this second charge transfer, a third transition TRT3 of the mode control signal DCG is applied by the control circuit.

This third transition TRT3, opposite to the second transition, enables the pixel to be placed back in its high conversion gain HCG mode.

As illustrated by the circle ZN in FIG. 4, there is a pulse (“return trip”) of the signal DCG which frames the pulse TG2 of the transfer signal TG.

And during the third transition TRT3, a charge injection, identical but opposite to that which occurred during the second transition TRT2, takes place.

At the end of this return trip of the signal DCG, the mode control transistor TDCG will not have caused any injection of residual charges likely to disturb pixel reading.

Hence, the reference value REF obtained during the first conversion, which was valid for the HCG conversion, remains valid for the LCG conversion.

A single ramp will therefore be used for this LCG conversion and there is no need for a fourth ramp, unlike the four ramps used in prior art cited hereinbefore.

This results in a reduced reading time, typically a time reduction in the order of 30 to 35% relative to this prior art, which uses four ramps.

As has just been stated, the control circuit MCM activates the ramp generator GENR, subsequent to the third transition TRT3 of the signal DCG, in order to have a third ramp signal RAMP3 delivered by the ramp generator.

The comparison circuit CMP carries out a comparison of a third output voltage VX delivered to the output node NS of the pixel with the third ramp signal RAMP3.

The generation circuit MLB determines a third digital counting value SIG_{LCG} representative of a third duration between the start T0 of the third ramp signal and a third instant T3 (schematically represented in FIG. 4) when said third output voltage intersects the third ramp signal.

And then the value SIG_{LCG} is transmitted to the memory location MM3 using the counter transfer signal CTRT.

The third conversion (LCG conversion) as well as the pixel reading operation are completed.

The reading control signal READ falls back to the low state and the pixel is reset (signal RST to the high state) for the next reading operation.

In FIG. 4, reference CSN1 designates the curve of the voltage at the reading node SN1 of the pixel when the pixel is reset and the first conversion is performed.

Reference CSN2 designates the curve of the voltage at the first terminal BC21 of the second capacitor Cₛₙ₂ when the pixel is reset and the first conversion is performed.

Reference CSN1a designates the curve of the voltage at the pixel reading node SN1 during the next two HCG and LCG conversions in the case where charges remain in the photodiode after the first charge transfer (saturation of the reading device).

Reference CSN2a designates the curve of the voltage at the first terminal BC21 of the second capacitor Cₛₙ₂ during the next two conversions HCG and LCG in the case where charges remain in the photodiode after the first charge transfer (saturation of the reading device).

Reference CSN1b designates the curve of the voltage at the pixel reading node SN1 during the next two HCG and LCG conversions in the case where no charge remains in the photodiode after the first charge transfer (no saturation of the reading device).

Reference CSN2b designates the curve of the voltage at the first terminal BC21 of the second capacitor Cₛₙ₂ during the next two HCG and LCG conversions in the case where no charge remains in the photodiode after the first charge transfer (no saturation of the reading device).

ΔV_{HCG} and ΔV_{LCG} designate the voltage differences during the two respective HCG and LCG conversions between the level of curves CSN1, CSN2 and the level of curves CSN1a, CSN1b and the level of curves CSN2a, CSN2b, respectively.

The system SYS comprises calculation means configured to deliver a difference SIG_{HCG}−REF between the second digital counting value SIG_{HCG} and the first digital counting value REF, and a difference SIG_{LCG}−REF between the third digital counting value SIG_{LCG} and the first digital counting value REF.

At the end of the reading operation, the values REF, SIG_{HCG}, SIG_{LCG} are respectively transmitted on the bit lines BL1, BL2, BL3 to the calculation circuit MCL in order to calculate the differences (SIG_{HCG}−REF) and (SIG_{LCG}−REF) from which the value of the pixel with dynamic extension is calculated in a conventional and known manner.

Alternatively, using a 1-bit adder, it would be possible to deliver differences (SIG_{HCG}−REF) and (SIG_{LCG}−REF) directly to the memory locations so that these differences can be delivered on two bit lines to the calculation circuit MCL for calculating value of the dynamic range of the pixel.

This means there is only one two-wire bus, which saves space.

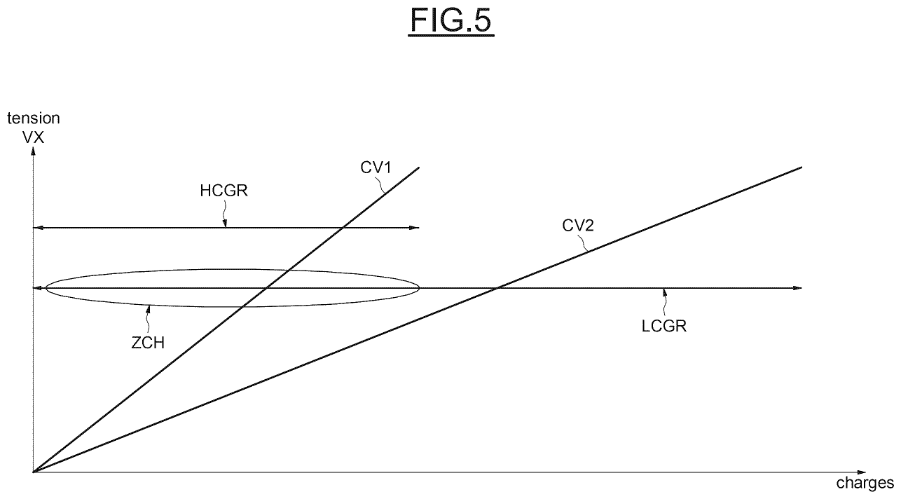

In FIG. 5, reference CV1 designates the voltage/load curve for HCG conversion (HCGR zone) and reference CV2 designates the voltage/load curve for LCG conversion (LCGR zone).

It is noticed that there is an overlapping zone ZCH.

It is therefore preferable not to convert this zone twice.

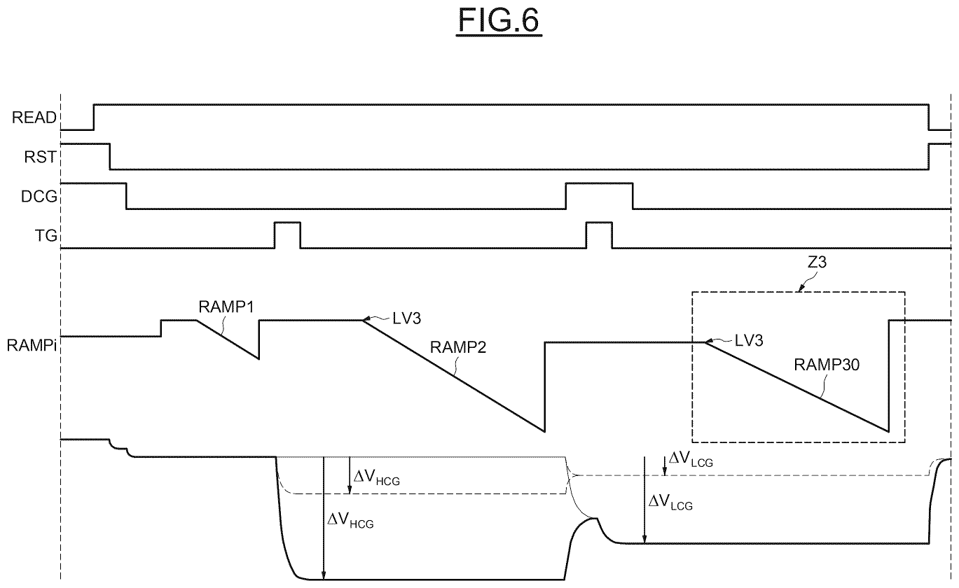

For this reason, the mode of implementation schematically illustrated in FIG. 6 can be used.

FIG. 6 is identical to FIG. 4 except for the zone Z3. For the sake of simplicity, some of the references in FIG. 4 are not shown in FIG. 6.

Only zone Z3 will now be described.

This zone Z3 shows that the third ramp signal RAMP30, used for the LCG conversion in this mode of implementation, starts at a level LV3 lower than the level LV2 at which the first RAMP1 and second RAMP2 ramp signals start.

This means that the overlapping zone ZCH illustrated in FIG. 5 is not converted twice.

As a result, whereas the reading operation is performed with a short ramp RAMP1 and two long ramps RAMP2, RAMP3 in the mode of implementation of FIG. 4, it is performed with a short ramp RAMP1, a long ramp RAMP2 and a medium ramp RAMP30 in the mode of implementation of FIG. 6, leading to an even greater reduction in the time taken for the reading operation.

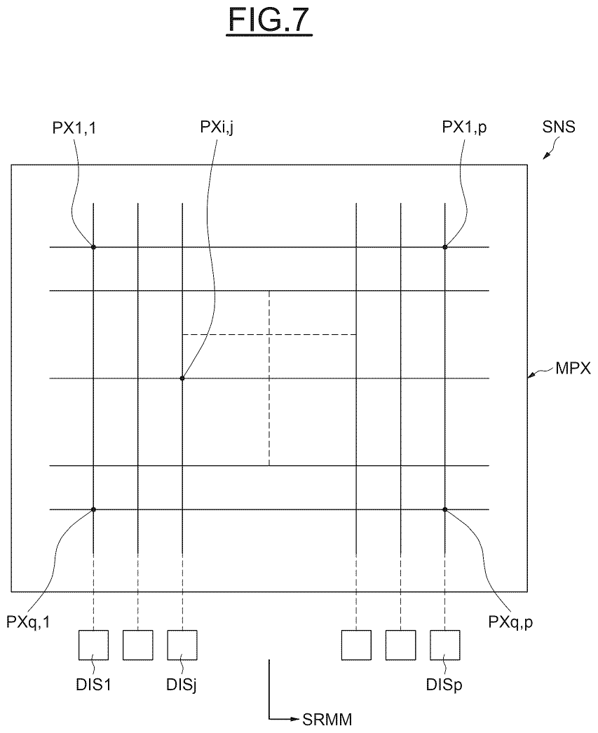

FIG. 7 schematically illustrates a sensor SNS including a matrix MPX of pixels PXI, j here having q rows and p columns.

The pixels of a row are simultaneously read using the method that has just been described.

Then the process proceeds to the next row until the entire matrix is read.

Consequently, the sensor SNS includes, coupled for example at the foot of each of the p columns, p reading devices DIS1-DISSp, identical to the DIS previously described, and connected to the memory SRMM.

1. A method for reading a pixel with charge/voltage dual conversion gain, the pixel having a photodiode configured to store charges and a reading node, wherein the pixel is placeable in response to a mode control signal into either a high conversion gain mode or a low conversion gain mode, the method comprising a reading operation successively including the following steps:
a) a reset of the reading node of the pixel placed in the low conversion gain mode, followed by a first transition of the mode control signal so as to place the pixel in the high conversion gain mode;
b) with the pixel in the high conversion gain mode, a first charge transfer from the photodiode to the reading node with a high conversion gain; and
c) a second transition of the mode control signal so as to place the pixel in the low conversion gain mode, followed by a second charge transfer from the photodiode to the reading node with a low conversion gain, followed by a third transition of the mode control signal, opposite to the second transition, so as to place the pixel back in the high conversion gain mode.

2. The method according to claim 1, wherein the pixel includes an output node connected to the reading node, and wherein step a) also includes, subsequent to the first transition of the mode control signal, a comparison of a first output voltage delivered to the output node with a first ramp signal and a determination of a first digital counting value representative of a first duration between the start of the first ramp signal and a first instant when said first output voltage intersects the first ramp signal.

3. The method according to claim 1, wherein the pixel includes an output node connected to the reading node, and wherein step b) also includes, subsequent to the first charge transfer, a comparison of a second output voltage delivered to the output node with a second ramp signal and a determination of a second digital counting value representative of a second duration between the start of the second ramp signal and a second instant when said second output voltage intersects the second ramp signal.

4. The method according to claim 1, wherein the pixel includes an output node connected to the reading node, and wherein step c) also includes, subsequent to the third transition of the mode control signal, a comparison of a third output voltage delivered to the output node with a third ramp signal and a determination of a third digital counting value representative of a third duration between the start of the third ramp signal and a third instant when said third output voltage intersects the third ramp signal.

5. The method according to claim 4, wherein step b) also includes, subsequent to the first charge transfer, a comparison of a second output voltage delivered to the output node with a second ramp signal and a determination of a second digital counting value representative of a second duration between the start of the second ramp signal and a second instant when said second output voltage intersects the second ramp signal; and wherein the third ramp signal starts at a level lower than the level of the start of the second ramp signal.

6. The method according to claim 5, further comprising, following the reading operation, delivering a difference between the second digital counting value and the first digital counting value, and delivering a difference between the third digital counting value and the first digital counting value.

7. A circuit for reading a pixel configured to implement the method of claim 1.

8. A system, comprising:
a pixel having a photodiode configured to store charges and a reading node, wherein the pixel is placeable in response to a control signal in either a high conversion gain mode or a low conversion gain mode; and
a circuit configured to read the pixel with charge/voltage conversion dual conversion gain, the circuit including a processing circuit configured to deliver said control signal and to implement a reading operation that successively includes:
a) a reset of the reading node of the pixel placed in the low conversion gain mode, followed by a first transition of the mode control signal to place the pixel in the high conversion gain mode;
b) with the pixel in the high conversion gain mode, a first charge transfer from the photodiode to the reading node with a high conversion gain; and
c) a second transition of the control signal to place the pixel in the low conversion gain mode, followed by a second charge transfer from the photodiode to the reading node with a low conversion gain, followed by a third transition of the control signal, opposite to the second transition, to place the pixel back in the high conversion gain mode.

9. The system according to claim 8, wherein the pixel includes an output node connected to the reading node, and the processing circuit includes a ramp generator configured to deliver ramp signals, a comparison circuit, a generation circuit and a control circuit, and wherein the implementation of step a) comprises:
the control circuit causing the ramp generator to deliver the first ramp signal subsequent to the first transition of the mode control signal;
the comparison circuit carrying out a comparison of a first output voltage delivered to the output node with the first ramp signal; and
the generation circuit determining a first digital counting value representative of a first duration between the start of the first ramp signal and a first instant when said first output voltage intersects the first ramp signal.

10. The system according to claim 9, further comprising:
a memory configured to store the first digital counting value; and
a calculation circuit configured to perform a calculation on the first digital counting value

11. The system according to claim 8, wherein the pixel includes an output node connected to the reading node, and the processing circuit includes a ramp generator configured to deliver ramp signals, a comparison circuit, a generation circuit and a control circuit, and wherein the implementation of step b) comprises:
the control circuit causing the ramp generator to deliver a second ramp signal subsequent to the first charge transfer;
the comparison circuit carrying out a comparison of a second output voltage delivered to the output node with the second ramp signal; and
the development circuit determining a second digital counting value representative of a second duration between the start of the second ramp signal and a second instant when said second output voltage intersects the second ramp signal.

12. The system according to claim 11, further comprising:
a memory configured to store the second digital counting value; and
a calculation circuit configured to perform a calculation on the second digital counting value

13. The system according to claim 8, wherein the pixel includes an output node connected to the reading node, and the processing circuit includes a ramp generator configured to deliver ramp signals, a comparison circuit, a generation circuit and a control circuit, and wherein the implementation of step c) comprises:
the control circuit causing the ramp generator to deliver a third ramp signal subsequent to the third transition of the mode control signal;
the comparison circuit carrying out a comparison of a third output voltage delivered to the output node with the third ramp signal; and
the generation circuit determining a third digital counting value representative of a third duration between the start of the third ramp signal and a third instant when said third output voltage intersects the third ramp signal.

14. The system according to claim 13, further comprising:
a memory configured to store the third digital counting value; and
a calculation circuit configured to perform a calculation on the third digital counting value.

15. The system according to claim 13, wherein the implementation of step b) comprises:
the control circuit causing the ramp generator to deliver a second ramp signal subsequent to the first charge transfer;
the comparison circuit carrying out a comparison of a second output voltage delivered to the output node with the second ramp signal; and
the development circuit determining a second digital counting value representative of a second duration between the start of the second ramp signal and a second instant when said second output voltage intersects the second ramp signal; and
wherein the ramp generator is configured to deliver the third ramp signal starting at a level lower than the level of the start of the second ramp signal.

16. The system according to claim 15, further comprising:
a memory configured to store the second and third digital counting values; and
a calculation circuit configured to perform a calculation on the second and third digital counting values.

17. The system according to claim 16, further comprising a calculation circuit configured to deliver a difference between the second digital counting value and the first digital counting value, and deliver a difference between the third digital counting value and the first digital counting value.

18. The system according to claim 8, further comprising:
transfer transistor, controlled by a transfer signal, connected between the photodiode and the reading node;
a first capacitor having a first terminal connected to the reading node and a second terminal connected to ground;
a second capacitor having a first terminal and a second terminal connected to ground; and
a mode transistor, controlled by the mode control signal, connecting together the first terminals of the capacitors.

19. The system according to claim 18, further comprising a reset transistor, controlled by a reset signal, connected between the first terminal of the second capacitor and the mode transistor on the one hand, and a supply voltage on the other hand.

20. A sensor, including:
a pixel matrix organized in rows and columns;
each pixel of the pixel matrix having a photodiode configured to store charges and a reading node, wherein the pixel is placeable in response to a control signal in either a high conversion gain mode or a low conversion gain mode; and
a reading device respectively connected to each column, said reading device comprising a circuit configured to read the pixel with charge/voltage conversion dual conversion gain, the circuit including a processing circuit configured to deliver said control signal and to implement a reading operation that successively includes:
a) a reset of the reading node of the pixel placed in the low conversion gain mode, followed by a first transition of the mode control signal to place the pixel in the high conversion gain mode;
b) with the pixel in the high conversion gain mode, a first charge transfer from the photodiode to the reading node with a high conversion gain; and
c) a second transition of the control signal to place the pixel in the low conversion gain mode, followed by a second charge transfer from the photodiode to the reading node with a low conversion gain, followed by a third transition of the control signal, opposite to the second transition, to place the pixel back in the high conversion gain mode.

21. The sensor according to claim 20, wherein each pixel includes an output node connected to the reading node, and the processing circuit includes a ramp generator configured to deliver ramp signals, a comparison circuit, a generation circuit and a control circuit, and wherein the implementation of step a) comprises:
the control circuit causing the ramp generator to deliver the first ramp signal subsequent to the first transition of the mode control signal;
the comparison circuit carrying out a comparison of a first output voltage delivered to the output node with the first ramp signal; and
the generation circuit determining a first digital counting value representative of a first duration between the start of the first ramp signal and a first instant when said first output voltage intersects the first ramp signal.

22. The system according to claim 20, wherein each pixel includes an output node connected to the reading node, and the processing circuit includes a ramp generator configured to deliver ramp signals, a comparison circuit, a generation circuit and a control circuit, and wherein the implementation of step b) comprises:
the control circuit causing the ramp generator to deliver a second ramp signal subsequent to the first charge transfer;
the comparison circuit carrying out a comparison of a second output voltage delivered to the output node with the second ramp signal; and
the development circuit determining a second digital counting value representative of a second duration between the start of the second ramp signal and a second instant when said second output voltage intersects the second ramp signal.

23. The sensor according to claim 20, wherein each pixel includes an output node connected to the reading node, and the processing circuit includes a ramp generator configured to deliver ramp signals, a comparison circuit, a generation circuit and a control circuit, and wherein the implementation of step c) comprises:
the control circuit causing the ramp generator to deliver a third ramp signal subsequent to the third transition of the mode control signal;
the comparison circuit carrying out a comparison of a third output voltage delivered to the output node with the third ramp signal; and
the generation circuit determining a third digital counting value representative of a third duration between the start of the third ramp signal and a third instant when said third output voltage intersects the third ramp signal.

24. The sensor according to claim 23, wherein the implementation of step b) comprises:
the control circuit causing the ramp generator to deliver a second ramp signal subsequent to the first charge transfer;
the comparison circuit carrying out a comparison of a second output voltage delivered to the output node with the second ramp signal; and
the development circuit determining a second digital counting value representative of a second duration between the start of the second ramp signal and a second instant when said second output voltage intersects the second ramp signal; and
wherein the ramp generator is configured to deliver the third ramp signal starting at a level lower than the level of the start of the second ramp signal.
